(19) United States
(12) Patent Application Publication
(10) Pub. No.: US 2006/0169858 A1
(43) Pub. Date: Aug. 3, 2006

(54) Resilient safety support device

(75) Inventor: Todd D. Krueger, Lillington, NC (US)

Correspondence Address: COATS & BENNETT, PLLC, P O BOX 5, RALEIGH, NC, 27602, US

(73) Assignee: Bob Barker Company, Inc.

(21) Appl. No.: 11/050,313

(22) Filed: Feb. 3, 2005

(51) Int. Cl. F16B 45/00

(52) U.S. Cl. 248/304

(57) ABSTRACT

A safety hook having a first member with a resilient stem. The first member also has a base with a larger cross-section than the stem. A second member is substantially disc-shaped and has an annular mounting surface disposed on a first side of the disc. The second member further includes a recess, also disposed on the first side of the disc, but interior to the annular mounting surface. The safety hook is installed with the annular mounting surface placed in contact with a mounting location and the base of the first member disposed within the recess and the stem protruding through the second member to a second side of the disc. The stem is positioned with the open end of the U-shape oriented upward so that the stem supports a downward force, but flexes under the influence of loads applied in other directions.

### BACKGROUND

Institutional facilities, including correctional facilities, hospitals, schools, and the like house individuals needing protection from injury. These same institutional facilities have a need to store goods, equipment, clothing, and the like in a manner that will create a safe environment. Unfortunately, storage devices, such as racks, shelves, and hooks, commonly include, or are comprised of, rigid hardware that may pose a danger to individuals within these institutions. Conventional hardware such as screws, brackets, and hooks are usually manufactured from metal or other rigid materials. This hardware is also commonly installed so that they protrude outward from a mounting surface. Furthermore, hardware of this type may also have sharp edges or corners that are merely a by-product of the manufacturing process. Thus, this type of hardware poses a danger of cutting individuals who brush against the hardware. Worse yet, impaling injuries may occur when individuals are pushed or fall against this hardware.

In addition to the aforementioned hazards that exist while hardware is installed as intended, a further hazard arises because the brackets and hooks may be removable. These devices often protrude from a mounting surface a substantial amount, which allows individuals to grab onto the hardware and pry it from its intended location. Once removed, these pieces of hardware may be sharpened for later use as weapons.

### SUMMARY

One embodiment disclosed is a two-part safety support device having a base and a resilient hook protruding from the base. The resilient hook supports a load applied in a first direction, but flexes when a load is applied in a direction substantially different than the first direction. In general, the support device may be used to support hanging items. Thus, the first direction may be in a direction of gravitational pull. The base may be substantially disc-shaped with the resilient hook protruding from a first side of the base through to a second side of the base. The base has a mounting surface and a recess disposed on the first side of the base. The hook has an anchor that fits within the recess when the mounting surface abuts a mounting location so that when the support device is installed, the hook may be captively retained between the base and the mounting location. In general, the hook protrudes from the second side of the base a small amount to limit grabbing or pulling surface area.

One embodiment of the hook has a resilient stem with a substantially U-shaped cross section. The aforementioned anchor has a larger cross-section than the stem. The anchor may be sized and shaped to fit within the recess of the base. When the support device is installed, the anchor of the hook is captively retained within the recess of the base. The stem of the hook protrudes through an aperture in the base to a second side of the base. The aperture may be shaped to approximately match the shape of the stem and prevent rotation of the stem once the device is installed. In addition, the anchor may also be resilient and compress within the recess when the base member is affixed to a mounting location. To support a downward force, the hook may be positioned so that the open end of the U-shaped stem is oriented substantially upward.

The support device may be modular and adapted to support varying loads depending on a particular hook chosen in a given application. Thus, a plurality of interchangeable hook members may be used, each of which being flexible and being similar in shape but having a different rigidity. Thus, different hooks may be operatively combined with the base to create a load-bearing structure that supports different loads applied in a first direction but that still yields in response to a load applied in different directions. For instance, a more rigid hook may be used to support larger loads. Conversely, a less rigid hook may be used to support smaller loads. The rigidity of the hooks may be identified by markings on the hooks identifying some measure of stiffness, such as a durometer hardness value or weight capacity. Selection of the appropriate hook for a given load may also be achieved by color-coding the hooks having a varying rigidity.

### BRIEF DESCRIPTION OF THE DRAWINGS

FIG. 1 is a perspective view of one embodiment of a support device of the present invention;

FIG. 2 is an exploded perspective view of a support device having a base member that can be used in combination with one of a plurality of different hook members according to one embodiment of the present invention;

FIG. 3 is a perspective view of one embodiment of a support device of the present invention;

FIG. 4 is an exploded perspective view of one embodiment of a support device of the present invention;

FIG. 5 is a side view of one embodiment of a hook member of the present invention;

FIG. 6 is a front view of one embodiment of a hook member of the present invention;

FIG. 7 is a side view of one embodiment of a base member of the present invention;

FIG. 8 is a front view of one embodiment of a base member of the present invention;

FIG. 9 is a side view of one embodiment of a support device of the present invention;

FIG. 10 is a rear view of one embodiment of a support device of the present invention;

FIG. 11 is a front view of one embodiment of a support device of the present invention;

FIG. 12 is a top view of one embodiment of a support device of the present invention;

FIG. 13a is a side section view of one embodiment of a support device of the present invention;

FIG. 13b is a side section view of one embodiment of an installed support device of the present invention;

FIG. 14 is an exploded perspective view of one embodiment of a support device of the present invention;

FIG. 15 is a top view of one embodiment of a support device of the present invention;

FIG. 16 is a top view of one embodiment of a support device of the present invention;

FIG. 17 is a front view of one embodiment of a hook member of the present invention;

FIG. 18 is a front view of one embodiment of a hook member of the present invention;

FIG. 19 is a front view of one embodiment of a hook member of the present invention; and

FIG. 20 is a front view of one embodiment of a hook member of the present invention.

### DETAILED DESCRIPTION

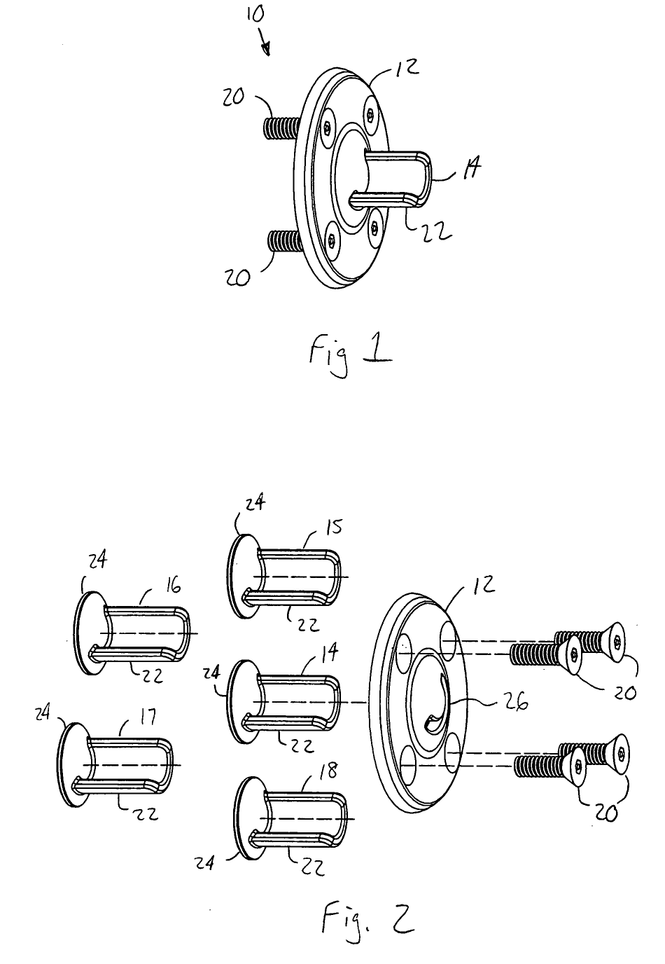

One embodiment of a safety support device, generally designated by the number 10, is shown in FIG. 1. The support device 10 includes a base member 12 and a hook member 14. In the embodiment shown, the support device further comprises a plurality of mounting screws 20 for securing the base member 12 to a mounting surface (not shown), such as a wall, a bracket, shelving, or some other suitable location. These screws 20 may have tamper-resistant driving features as needed or desired. An exploded view of the support device 10 is shown in FIG. 2 where it is more clearly visible that the hook member 14 is a separate component from base member 12. FIG. 2 also shows a plurality of additional hook members 15-18, any one of which may be combined with base member 12 to form the assembled support device 10 as in FIG. 1.

Each hook member 14-18 is resiliently flexible. However, each hook member 14-18 has a different rigidity and stiffness than the other hook members 14-18. Thus, the interchangeable hook members 14-18 may be selected to achieve a desired load-bearing capability. The hook members 14-18 may be constructed of a variety of materials. In one embodiment, the hook members 14-18 are comprised of a thermoplastic material, such as Santoprene®. Other embodiments include elastomers, including urethane or other rubberized materials.

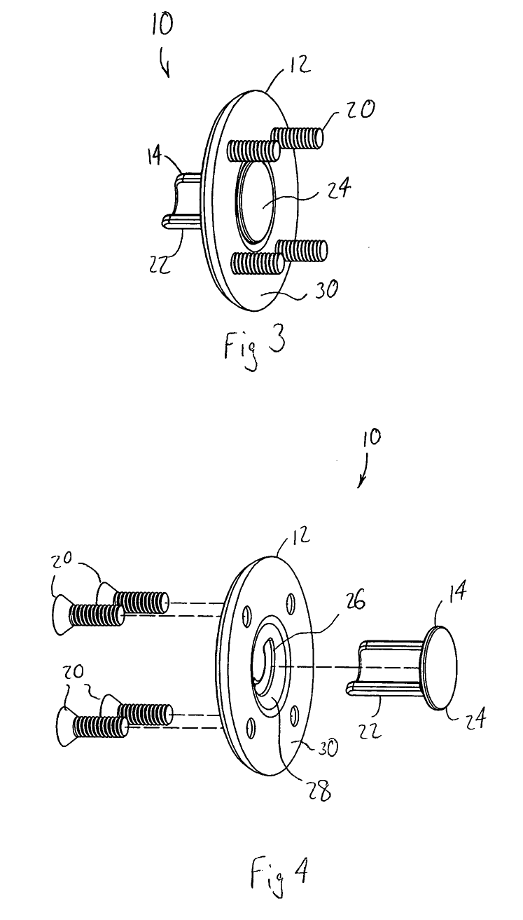

As is visible in FIG. 2, each hook member 14-18 has a stem portion 22 and an anchor portion 24. When assembled as shown in FIG. 1 and FIG. 3, the stem portion 22 protrudes through an aperture 26 in the base member 12. The reverse-angle perspective view shown in FIG. 3 reveals that the anchor portion 24 is disposed on the same side of the base member 12 as mounting surface 30. That is, the anchor portion 24 is disposed on the side of base member 12 opposite the stem portion 22. The exploded view of the support device 10 shown in FIG. 4 reveals a recess 28 within which the anchor portion 24 is disposed when the support device is assembled and installed (as in FIGS. 1 and 3). The recess 28 is generally disposed on the same side of, and interior to, mounting surface 30. In the embodiment shown, the mounting surface 30 is annular and the recess 28 is domed.

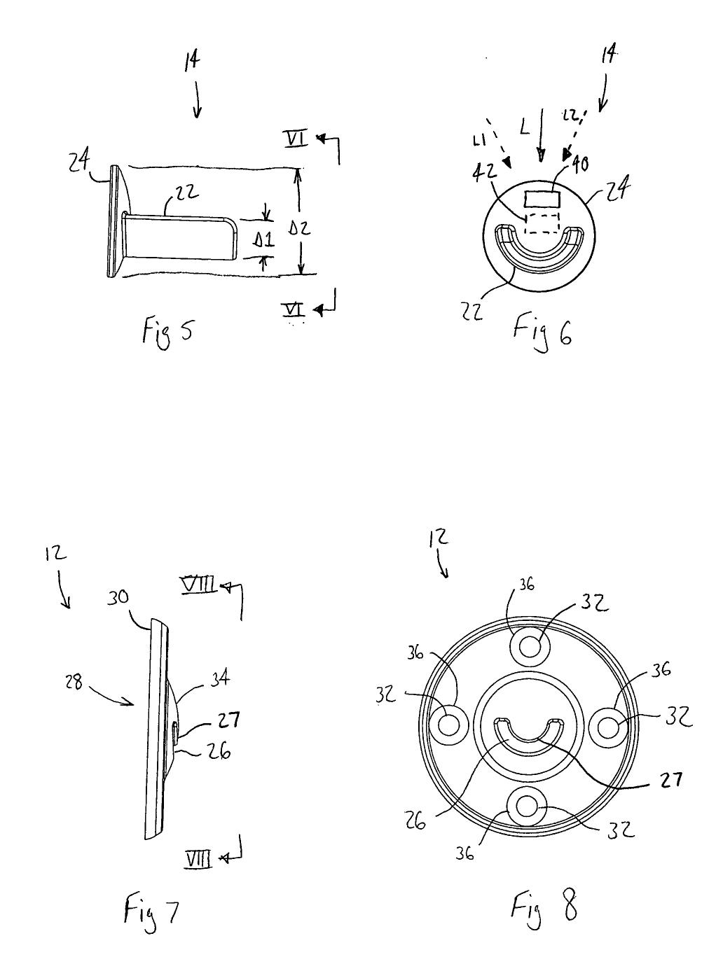

FIG. 5 shows a side view of a representative hook member 14 illustrating the enlarged anchor portion 24. FIG. 5 qualitatively depicts a larger dimension D2 as compared to that of the stem portion 22. In one embodiment, dimension D2 may have a value of about 1 inch whereas dimension D1 may have a value of about ⅜ inch. Because dimension D2 is larger than dimension D1, the hook member 14 may effectively be retained within the support device 10 when assembled as shown in FIGS. 1 and 3.

FIG. 6 shows a frontal view of the hook member 14. This particular view shows a generally U-shaped or concavo-convex cross section of the stem portion 22. This cross-section improves the bending strength of the stem, particularly in the direction of a load L applied in the direction shown in FIG. 6. For a cantilevered beam, the rigidity of the beam and deflection resistance is a function of the flexural rigidity and section modulus for the beam shape. The section modulus of a structural shape is a function of the cross sectional height of a shape and the bending moment of inertia and is commonly used to determine maximum stresses due to bending moments in beams. For the U-shape cross section, the section modulus is larger in the direction of load L and smaller in other directions. Consequently, the channeled stem portion 22 may be suited to bear substantial loads applied in the direction L shown. Furthermore, because of the resilient nature of the hook member 14, loads applied in directions transverse to or substantially different than that shown for load L may generally cause the stem to flex. It should be noted then, that the load L is generally applied in the direction of the open portion of the U-shape or channeled cross section. Loads that are applied in a direction transverse to or other than into the open portion of the cross section shape may cause the stem to flex. In one application of the present embodiment, the device 10 may be positioned so that the open portion of the channeled cross section is oriented in a direction opposite to the direction of gravitational pull. In such an application, the support device 10 may advantageously support hanging loads up to a predetermined capacity. Furthermore, loads applied in other directions (such as L1 and L2 in FIG. 6) but still into the open portion of the channel cross section may still be supported. There is no express requirement that the load be applied in a direction perpendicular to the channel cross section.

As discussed previously, hook member 14 is but one of a plurality of hook members 14-18 that may be used with the support device 10 (see FIG. 2). Each hook member 14-18 has a different rigidity and stiffness, meaning each hook member 14-18 is capable of supporting different loads L. To distinguish between the different hook members 14-18, the individual hook members 14-18 may include a distinguishing mark 40 on the hook member. The distinguishing mark 40 may be included in any visible location on the hook member 14-18. For instance, it may be desirable to place a mark 42 on the rear face of anchor portion 24 or perhaps even on an exposed part of the stem portion 22. A variety of different distinguishing marks may be used. In one embodiment, a hardness measurement, which correlates to the rigidity and stiffness of the hook member 14, may be used. For example, a Shore Durometer or Rockwell hardness value may be placed on the hook member. In another embodiment, a load rating in pounds or kilograms may be marked on the hook member 14-18. In another embodiment, the different hook members 14-18 may be color coded to distinguish among the varying rigidities and stiffnesses. The color coding may comprise a color stamp, a color marking, or the entire part may be manufactured with a different color base material.

Similar views to those provided in FIGS. 5 and 6 are provided for the base member 12 in FIGS. 7 and 8. In particular, FIG. 7 shows a side view of one embodiment of the base member 12, which is substantially disc-shaped. In the embodiment presented, the mounting surface 30 is substantially flat for mounting onto a flat mounting location (not shown).

Also visible in FIG. 7 (as well as FIG. 8) is the aperture 26 through which the stem portion 22 of hook member 14 is inserted. The recess 28 in which the anchor portion 24 is disposed is not visible in FIG. 7, however a corresponding bulge 34 can be seen on the right side of the base member 12. This exterior bulge 34 generally follows the contours of the recess 28 and permits the base member 12 to have a substantially uniform thickness across the part. The base member 12 may be constructed from a variety of materials, including resins, thermoplastics, or metals. ABS and PVC are but two examples of suitable material choices.

FIG. 8 shows a front view of the base member 12, where the aperture 26 is more clearly visible. The aperture 26 may be generally U-shaped to match the contour of the stem portion 22 of hook member 14. The shape and size of the aperture 26 shown in FIG. 8 provide several advantages. The aperture is sized so that when the hook member 14 is inserted into base member 12 as shown in FIGS. 1 and 3, the anchor portion 24 will not easily be pulled through the aperture or cannot be pulled through the aperture without visibly destroying the base member 12 or the hook member 14. In addition, since the aperture 26 is minimally larger in size than the stem portion 22, the aperture 26 may effectively prevent the hook member 14 from rotating. Thus, the hook member 14 may be positioned to repeatably bear loads applied in a given direction.

An added characteristic of the base member 12 is shown in FIGS. 7 and 8. The shape of aperture 26 creates a protrusion 27 that follows the contour of aperture 26, but does not extend outward so far as to create an unsafe condition. For instance, in the event the hook member 14 is removed from the base member 12, the base member 12, and particularly, protrusion 27 do not have any potentially injurious sharp edges or pointed features. Furthermore, in an installation where the channel-shaped aperture 26 is oriented generally upward as shown in FIGS. 7 and 8, the aperture 26 and protrusion 27 do not provide a solid catch or hook from which a rope or twine may be suspended or tied. In this manner, hanging type injuries may be prevented.

FIG. 8 also clearly shows a plurality of mounting features, embodied as through holes. These holes 32 may be used to secure the base member 12 to a mounting location (not shown) using a series of mounting screws 20 (see e.g., FIGS. 1-4). To conform to the low-profile nature of the base member 12, the screws 20 may be flat head screws that fit within a countersink 36. Alternatively, the mounting holes 32 may have counter-bores 36 into which the head of a pan-head or socket head screw 20 may be inserted.

FIGS. 9-12 show various views of a representative support device 10 comprising a base member 12 and hook member 14. It should be repeated that any of the additional hook members 15-18 shown in FIG. 2 may be substituted for the hook member 14 shown in FIGS. 9-12. FIG. 9 shows a load-bearing direction L for the support device 10. In general, the support member 10 may be used to support a variety of items, including without limitation, shelves, rods, and clothing. Bags and sacks may also be supported by placing a bag handle/strap/string over the stem portion 22 of hook member 14.

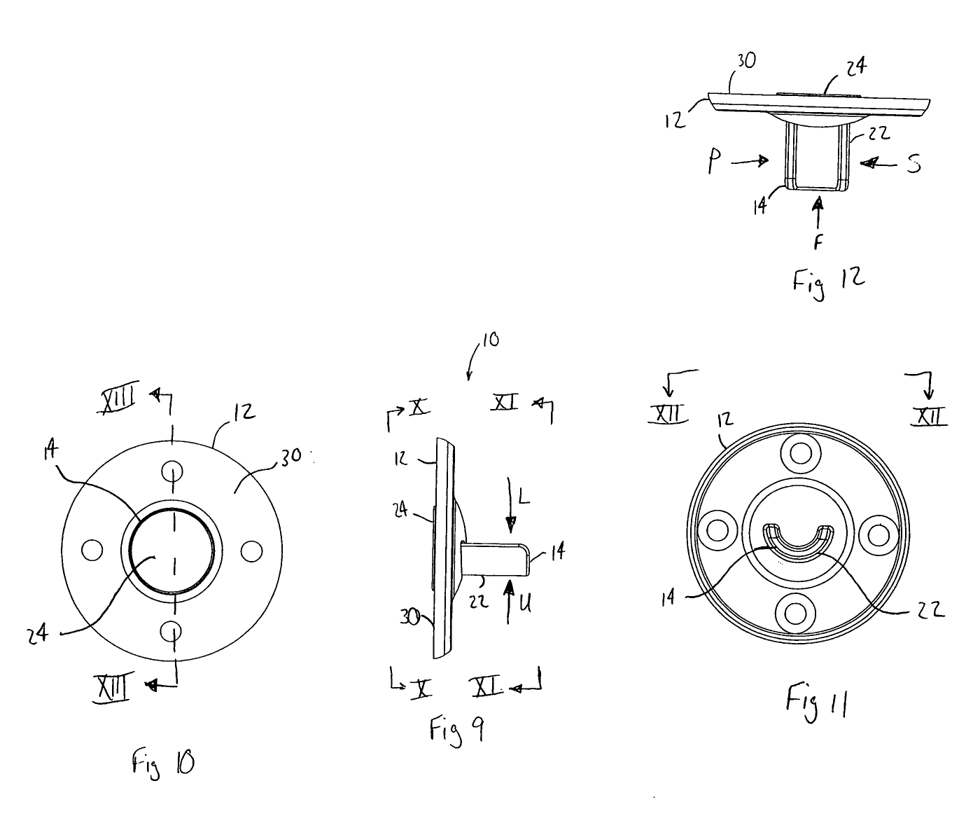

Since the hook member 14 is resiliently flexible, the stem portion 22 will flex when exposed to forces in the directions U (FIG. 9), P, F, or S (FIG. 12) are applied to the hook member 14. Thus, the support device 10 may prevent injury caused by persons contacting the protruding hook member 14.

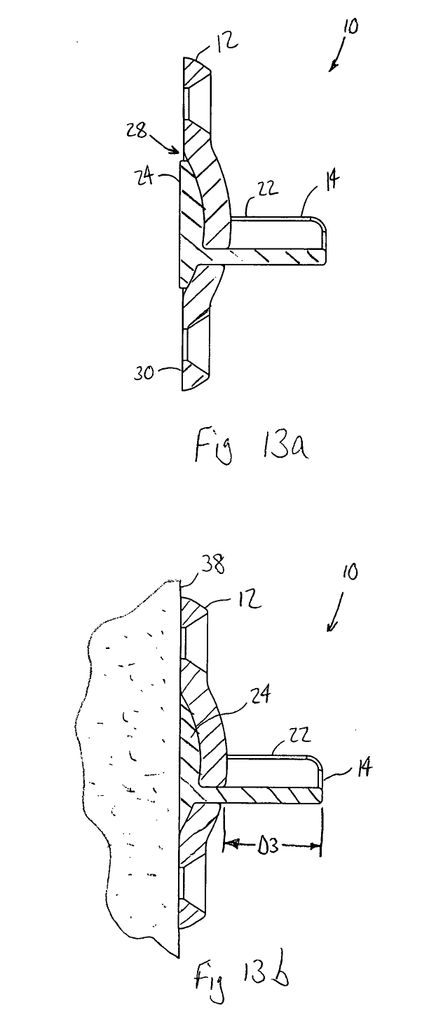

FIG. 9 shows that the anchor portion 24 of hook member 14 is not completely flush with the mounting surface 30 of the base member 12. This particular aspect of the support device 10 is shown more clearly in FIGS. 13a and 13b.FIG. 13a shows that despite the anchor portion 24 of hook member 14 being completely inserted in recess 28 of base member 12, the anchor portion 24 protrudes slightly beyond the plane formed by mounting surface 30. However, as the support device 10 is installed as shown in FIG. 13b, and the base member 12 is brought into contact with a mounting location 38, the anchor portion 24 compresses to completely fill recess 28 and sit flush with surface 30.

FIG. 13b also qualitatively shows that the hook member 14 protrudes from the base member 12 and mounting location 38 a minimal amount D3 so as to prevent persons from pulling the hook member 14 from its mounting location. In one embodiment, the dimension D3 is approximately 1 inch. Clearly, this dimension may be reduced as more rigid hook members 14 are used. Furthermore, while all numerical dimensions provided herein are representative of one specific embodiment, the respective sizes may be adjusted as needed to fit particular applications.

FIG. 14 represents an embodiment of a support device 80 comprising a base member 52 and hook member 54 having different shapes that those shown in support device 10. Specifically, base member 52 and hook member 54 have a generally square outer perimeter in contrast with the generally circular form of base member 12 and hook member 14. However, the remaining features and functionality of base member 52 and hook member 54 remain as previously described. For instance, the hook member 54 has a stem portion 56 and anchor portion 58. Similarly, the square base member 52 includes the aforementioned recess 60 into which the anchor portion 58 is inserted. Other shapes may certainly be incorporated. For instance, the outer perimeter of the base member 12, 52 may also be formed in the shape of a triangle, oval, or other desired shapes.

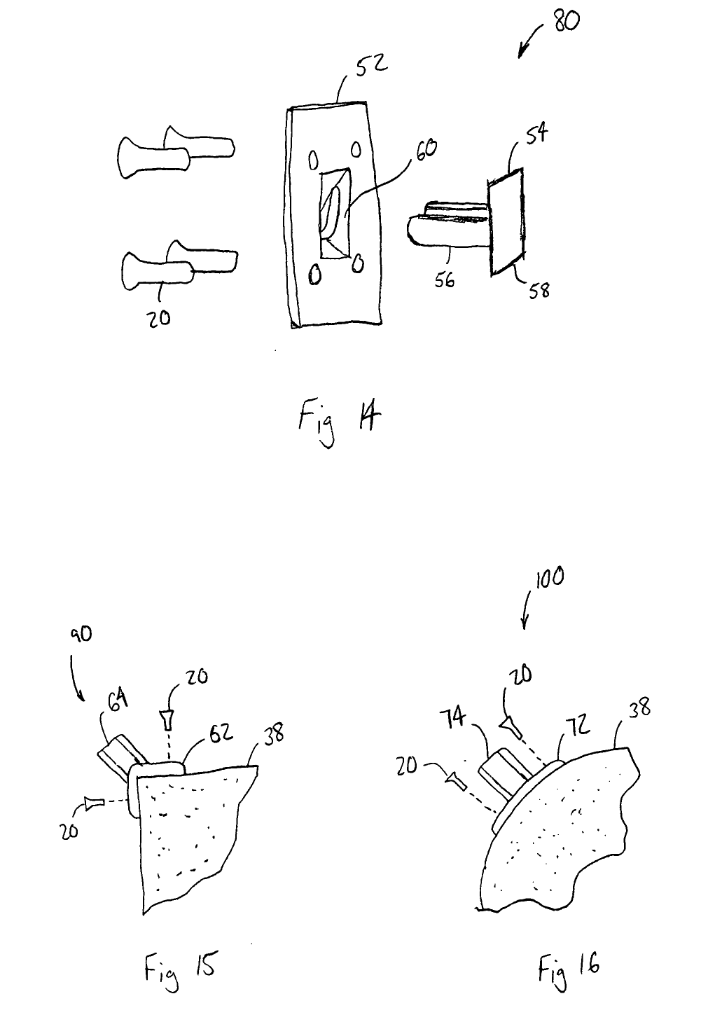

The base member 12 may also have different mounting surfaces as needed to conform to different mounting configurations. In the previously described embodiment of the base member 12, the mounting surface 30 was substantially flat. However, as shown in the top view of support device 90 in FIG. 15, a base member 62 may have a 90° bend for installation on a corner mounting location 38. In this particular embodiment of the support device 90, the hook member 64 protrudes outward from the corner installation. In another embodiment of the support device 100 shown in FIG. 16, the base member 72 may have a cylindrical mounting surface for mounting to a pole or other curved mounting location 38. As before, the hook member 74 protrudes outward from the mounting surface 38.

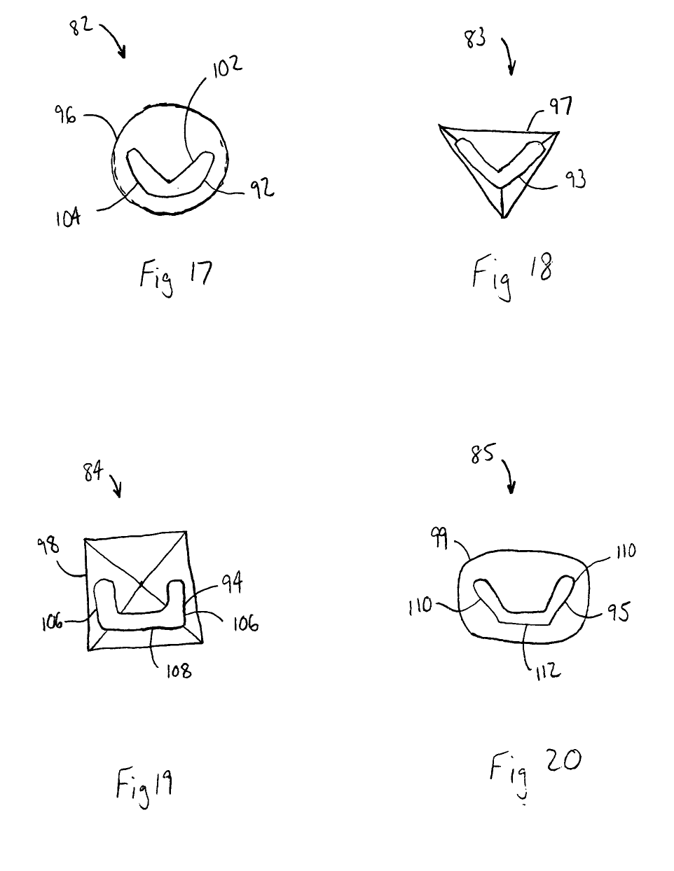

FIGS. 17-20 represent alternative embodiments of hook member 14, designated respectively as hook members 82-85. FIGS. 17-20 are front views of hook members 82-85, respectively, taken from the same perspective shown in FIG. 6 for hook member 14. Whereas hook member 14 includes a stem portion 22 having a general U-shape, other shapes are certainly possible. The embodiments provided in FIGS. 17-20 are a few non-limiting examples of other cross section shapes. FIG. 17 shows a stem portion 92 having a V-shaped upper surface 102 and a U-shaped lower surface 104. In the embodiment shown in FIG. 18, the hook member 83 has a stem portion 93 that is more uniformly V-shaped. By comparison, the hook member 84 shown in FIG. 19 has a stem portion 94 that a cross section in the form of a U-shaped channel. That is, the cross section of stem portion 94 is characterized by substantially vertical (as oriented in FIG. 19) side walls 106 and a substantially horizontal (as oriented in FIG. 19) connecting wall 108. A slight modification to this cross-section shape is provided in FIG. 20, where hook member 85 has a stem portion 95 has upwardly and outwardly (as oriented in FIG. 20) extending side walls 110 and a substantially horizontal (as oriented in FIG. 20) connecting wall 112. Clearly, where other cross section shapes are used for the stem portion 22 and 92-95, the aperture 26 in base member 12 may be made to closely match that of the stem portion 22.

FIGS. 17-20 further show that the hook member 14, 82-85 may have an anchor portion 24, 96-99 with different shapes. In the non-limiting examples shown in FIGS. 17-20, the outer perimeter of the anchor portions 96-99 have shapes ranging from circular to triangular to rectangular. Oval shapes are also possible, as are polygonal shapes such as squares, or hexagons. Furthermore, the corresponding recess 28, 60 in the base member 12, 52 (not specifically shown in FIGS. 17-20) may have a shape and contour that substantially matches that of the anchor portion 24, 54, and 96-99.

The present invention may be carried out in other specific ways than those herein set forth without departing from the scope and essential characteristics of the invention. For instance, the hook members 14-18 may have a uniform composition throughout and have a substantially uniform rigidity and stiffness. In another embodiment, the anchor portion 24 have a stiffer, more rigid composition to improve holding characteristics. In yet another embodiment, a single base member 12 may be adapted to secure a plurality of hook members 14. The present embodiments are, therefore, to be considered in all respects as illustrative and not restrictive, and all changes coming within the meaning and equivalency range of the appended claims are intended to be embraced therein.

What is claimed is:

1. A support device comprising:
a base; and
a resilient hook protruding from the base, the resilient hook having a channel cross-section adapted to support a load applied in a first direction substantially into the channel cross section, the resilient hook further adapted to flex when a load is applied in a second direction other than substantially into the channel cross section.

2. The support device of claim 1, wherein the base is substantially disc-shaped, the resilient hook protruding from a first side of the base to a second side of the base.

3. The support device of claim 2 wherein the hook protrudes from the second side of the base by less than about 1 inch.

4. The support device of claim 1, the base further comprising a mounting surface and a recess disposed on a first side of the base, and the hook further comprising an anchor, the anchor adapted to fit within the recess when the mounting surface abuts a mounting location.

5. The support device of claim 4 wherein the hook is captively retained between the base and the mounting location.

6. The support device of claim 1, wherein the channeled cross section is substantially U-shaped.

7. The support device of claim 1, wherein the channeled cross section is substantially V-shaped.

8. The support device of claim 1, the base further comprising a channel-shaped aperture through which the resilient hook having the channel cross-section protrudes.

9. The support device of claim 8 wherein an open portion of the channel-shaped aperture is oriented in a direction substantially opposite to a gravitational force.

10. A safety hook comprising:
a first member having a resilient first portion with a substantially U-shaped cross section, the first member further comprising a second portion having a larger cross-section than the first portion; and
a second member having a mounting surface and a recess disposed on a first side of the second member,
the mounting surface adapted to contact a mounting location, the second portion of the first member disposed within the recess of the second member and the first portion protruding from the first side of the second member to a second side of the second member.

11. The safety hook of claim 10 wherein the second member is substantially disc-shaped and the mounting surface is substantially annular and surrounds the recess.

12. The safety hook of claim 10 wherein second portion is resilient and compressed within the recess when the annular mounting surface contacts a mounting location.

13. The safety hook of claim 10 wherein the first member is positioned so that the U-shape of the first portion is oriented substantially upward.

14. The safety hook of claim 10 wherein the second member further comprises an aperture through which the first portion of the first member protrudes.

15. The safety hook of claim 14 wherein the aperture is substantially U-shaped.

16. The safety hook of claim 15 wherein an open portion of the substantially U-shaped aperture is oriented in a direction substantially opposite to a gravitational force.

17. The safety hook of claim 10 wherein the second member is more rigid than the first portion of the first member.

18. The safety hook of claim 10 further comprising mounting features for attaching the second member to the mounting location.

19. A load-bearing system for use in institutional facilities comprising:
a first member; and
a plurality of second members, each of the second members being flexible and having a different rigidity, and at least one of the second members being operatively combined with the first member to create a load-bearing structure that supports a load applied in a first direction but that yields in response to a load applied in a direction substantially transverse to the first direction.

20. The load-bearing system of claim 19 wherein the first member comprises a first surface adapted to be coupled to a mounting surface, the second member being captively retained by the first member when the first member is coupled to the mounting surface.

21. The load-bearing system of claim 19 wherein the plurality of second members are substantially similar in form.

22. The load-bearing system of claim 21 wherein the plurality of second members support different loads applied in the first direction in relation to the different rigidities.

23. The load-bearing system of claim 19 wherein the plurality of second members are individually marked to identify the rigidity of each of the plurality of the second members.

24. The load-bearing system of claim 19 wherein the plurality of second members are individually color-coded to identify the rigidity of each of the plurality of the second members.

25. The load-bearing system of claim 19 wherein the plurality of second members have a substantially U-shaped cross section.

26. A method of preventing injury caused by contact with a load-bearing apparatus, the method comprising:
inserting a hooking member through a base member;
captively securing the hooking member to a mounting location with the base member;
providing access to a protruding portion of the hooking member;
supporting a load applied in a first direction to the protruding portion of the hooking member;
resiliently flexing the protruding portion of the hooking member under the influence of a load applied in a direction substantially different than the first direction.

27. The method of claim 26 wherein the protruding portion of the hooking member is substantially U-shaped and the step of providing access to a protruding portion of the hooking member further comprises positioning the hooking member so that the open end of the U-shape is oriented substantially upward.

28. The method of claim 26 further comprising securing the hooking member by compressing an anchor portion of the hooking member between the base member and the mounting location.

29. The method of claim 26 wherein the first direction is substantially in the direction of a gravitational pull.

30. The method of claim 26 wherein captively securing the hooking member to a mounting location with the base member comprises compressing a portion of the hooking member between the base member and the mounting location.

31. A method supporting varying loads in institutional facilities comprising:
selecting a hooking member among a plurality of hooking members having a substantially similar form but having a different hardness;
inserting the selected hooking member through a base member;
captively securing the selected hooking member to a mounting location with the base member;
providing access to a protruding portion of the selected hooking member;
supporting a load applied in a first direction to the protruding portion of the selected hooking member;
resiliently flexing the protruding portion of the selected hooking member under the influence of a load applied in a direction substantially different than the first direction.

32. The method of claim 31 further comprising replacing the selected hooking member with a different one of the plurality of hooking members to change the magnitude of the load-supporting capability for the load applied in the first direction.

33. The method of claim 32 further comprising selecting a harder hooking member to increase the load-supporting capability.

34. The method of claim 32 further comprising selecting a softer hooking member to decrease the load-supporting capability.

35. The method of claim 31 wherein the protruding portion of the selected hooking member is substantially U-shaped and the step of providing access to a protruding portion of the selected hooking member further comprises positioning the selected hooking member so that the open end of the U-shape is oriented substantially upward.

36. The method of claim 31 wherein the first direction is substantially in the direction of a gravitational pull.

37. The method of claim 31 wherein captively securing the hooking member to a mounting location with the base member comprises compressing a portion of the hooking member between the base member and the mounting location.

38. The load-bearing system of claim 31 wherein selecting a hooking member among a plurality of hooking members having a substantially similar form but having a different hardness comprises reading markings on the hooking members to identify the rigidity of each of the plurality of the second members.

39. The load-bearing system of claim 31 wherein selecting a hooking member among a plurality of hooking members having a substantially similar form but having a different hardness comprises selecting a color associated with each of the hooking members to identify the rigidity of each of the plurality of the second members.
